(19) United States
(12) Patent Application Publication
(10) Pub. No.: US 2023/0142265 A1
(43) Pub. Date: May 11, 2023

(54) COMPOSTABLE MATERIAL FOR PACKAGING FOOD PRODUCTS

(71) Applicant: Luigi Lavazza S.p.A., Torino (IT)

(72) Inventors: Massimo DI MARCO, Torino (IT); Julie DIMAKOU, Cambridge (GB); Iain ARGYLE, Saffron Walden (GB)

(21) Appl. No.: 17/917,906

(22) PCT Filed: Mar. 24, 2021
(86) PCT No.: PCT/IB2021/052432

§ 371 Date: Oct. 7, 2022

(30) Foreign Application Priority Data
Apr. 8, 2020 (IT) 102020000007519

(51) Int. Cl. B65D 85/804; C08L 1/26; C08L 99/00; B65B 29/02; B65D 65/46

(52) U.S. Cl. CPC B65D 85/8046; C08L 1/26; C08L 99/00; B65B 29/022; B65D 65/466; C08L 2201/06

(57) ABSTRACT

A compostable material for packaging food products comprising a coffee-based granular material and at least one binding agent selected from methylcellulose, methylcellulose derivatives, mixtures thereof.

### TECHNICAL FIELD

The present disclosure relates to compostable materials for packaging food products.

Technological background Compostable materials for packaging food products are today known and commercially available in different forms according to the specific application. An ever-increasing interest is aimed at identification of compostable materials for packaging food products that are able to maintain their integrity even when they are subjected, for example, to thermal stresses and pressure. Moreover, materials for packaging food products have to meet requirements of suitability to contact with food. Characteristics of compostability, resistance to degradation, thermomechanical strength, suitability to contact with food may, however, not be easy to obtain simultaneously in one and the same product.

### OBJECT AND SUMMARY

The object of one or more embodiments of the present disclosure is to provide a compostable material suitable for packaging food products. In one or more embodiments, the compostable material is particularly suitable for the production of capsules designed to contain a dose of a food substance.

According to one or more embodiments, the above object is achieved thanks to a compostable material having the characteristics specified in the annexed claims.

The claims form an integral part of the technical teaching provided herein in relation to the embodiments.

### BRIEF DESCRIPTION OF THE FIGURES

One or more embodiments will now be described, purely by way of non-limiting example, with reference to the ensuing drawings, wherein:

FIG. 1 and FIG. 2 represent a capsule made of the compostable material according to embodiments of the present disclosure;

FIG. 3 and FIG. 4 represent a capsule made of the compostable material according to embodiments of the present disclosure;

FIG. 5 represents a block diagram regarding steps of a method of production of a capsule according to embodiments of the present disclosure;

FIG. 6 is a schematic illustration of a step of a method for the production of a capsule according to embodiments of the present disclosure;

FIG. 7 represents a block diagram regarding steps of the method of production of a capsule according to embodiments of the present disclosure;

FIG. 8 is a schematic illustration of a step of a method for the production of a capsule according to embodiments of the present disclosure;

FIG. 9 illustrates a histogram showing the results of experimental tests of migration carried out on compostable materials according to embodiments of the present disclosure;

FIG. 10 illustrates a histogram showing results of experimental tests carried out on compostable materials according to embodiments of the present disclosure.

### DETAILED DESCRIPTION

In the ensuing description various specific details are illustrated, aimed at enabling an in-depth understanding of examples of embodiments of the present disclosure. The embodiments may be obtained without one or more of the specific details, or with other methods, components, materials, etc. In other cases, known structures, materials, or operations are not illustrated or described in detail so that the various aspects of the embodiments will not be obscured.

Reference to “an embodiment” or “one embodiment” in the framework of the present disclosure is intended to indicate that a particular configuration, structure, or characteristic described in relation to the embodiment is comprised in at least one embodiment. Hence, phrases such as “in an embodiment” or “in one embodiment”, which may be present in various points of this description, do not necessarily refer to one and the same embodiment. Moreover, particular conformations, structures, or characteristics may be combined in any adequate way in one or more embodiments.

The references used herein are provided only for convenience and hence do not define the scope of protection or the scope of the embodiments.

The compostable material forming the subject of the present disclosure comprises a coffee-based granular material and at least one binding agent selected from methylcellulose, methylcellulose derivatives, mixtures thereof.

The methylcellulose derivatives may be selected in the group consisting of hydroxypropylmethylcellulose, carboxymethylcellulose, hydroxyethylmethylcellulose. Preferably, the binding agent is methylcellulose.

The compostable material may be used for packaging food products. An embodiment of the present disclosure provides a container for food comprising, preferably consisting of, the disclosed compostable material. Preferably, the container is a capsule that comprises a dose of at least one food substance, which may preferably be used in the preparation of a liquid product. The capsule obtained is an entirely compostable capsule that, after its use, can be disposed in wet waste.

The Inventors of the present application have noted, on the basis of specific tests described in what follows, that the disclosed compostable material presents the advantage of being usable for making containers for foodstuffs that do not alter the organoleptic properties of the food products contained therein. In this connection, and in order to test the suitability of the material to coming into contact with food, it has been subjected to “migration” tests. Such tests consist in determining the amount of substances that migrate from the materials themselves to a liquid (also defined as “simulating liquid”).

Migration tests have shown the suitability of the compostable material forming the subject of the present disclosure to contact with food. In addition, the compostable material described has proven particularly suitable for producing capsules containing a dose of a substance for the production of a liquid product.

The coffee-based material may consists of coffee in various forms, such as roasted and ground coffee, spent ground coffee (SGC), mixtures thereof.

The coffee-based granular material may comprise coffee in various forms, such as roasted and ground coffee, spent ground coffee (SGC), and mixtures thereof. In one or more embodiments, the coffee-based granular material may comprise, preferably may consist of, at least one from among roasted and ground coffee, spent ground coffee.

The spent ground coffee (post-consumer coffee or coffee after use thereof) may be obtained as by-product of industrial preparations (for example, such as by-product in the production of instant coffee and/or in the production of coffee-based beverages). Furthermore, the spent ground coffee may also derive from collection and recycling of waste deriving from preparations of coffee in the restaurant and catering sector (for example bars, restaurants) but also at home.

The binding agent is selected from methylcellulose, methylcellulose derivatives, mixtures thereof.

The binding agent, preferably methylcellulose, in combination with the coffee-based granular material, has made it possible to obtain a compostable material that is particularly suitable for the production of capsules containing a dose of food substance, for example capsules for the production of liquid products, such as coffee.

The specific combination of coffee-based granular material and binding agent, preferably methylcellulose, presents advantages both in terms of resistance of the compostable material and in terms of migration tests. Experimental tests conducted on compostable materials comprising binding agents different from methylcellulose or its derivatives, for example alginate, have, instead, presented non-optimal characteristics of use. Such materials may cause alterations in the organoleptic properties of food products and may undergo phenomena of decoloration, which are unpleasant from an aesthetic standpoint. Moreover, such materials have a poor liability to be moulded, and their use may be limited to procedures of spraying or dipping of the food product to be packaged. The present Inventors have noted that, in order to favour mouldability of such materials, in particular for the production of capsules for dispensing coffee, it becomes necessary to add to such materials at least one plasticizing agent, such as glycerol. Capsules obtained with compostable materials comprising glycerol—in combination with coffee and alginate—may, however, undergo bursting during the dispensing of the beverage.

The compostable material forming the subject of the present application, instead, maintains characteristics of stiffness such as to enable optimal dispensing, without releasing any powder or residue in the liquid product prepared and/or in the machine for the preparation of said liquid product. In particular, capsules made of the material described maintain their shape, elasticity, and sealing even when they are used in machines for dispensing liquid products, such as coffee, by introduction of water and/or steam at a temperature between 50° C. and 100° C. and a pressure between 1 bar and 30 bar.

Moreover, various parts of the capsule may be connected together purely by coupling by adhesion without the need to resort, for example, to coupling by gluing that could present critical aspects linked to the possible contact with the food substance.

The compostable material may comprise coffee-based granular material in a weight percentage comprised between 50 wt % and 80 wt % (wt/wt) of the compostable material.

The binding agent can be contained in the compostable material in an amount in weight comprised between 20 wt % and 50 wt % (wt/wt) of the compostable material.

The weight ratio between said granular material and said binding agent may be comprised between 1:1 and 4:1. Preferably, the weight ratio between said granular material and said binding agent is equal to 4:1.

The above weight ratio allows achieving a compostable material free of plasticizing agents, such as polyol compounds, and at the same time particularly suitable to be moulded.

In one or more embodiments, the compostable material consists of coffee-based granular material and binding agent, preferably methylcellulose.

The compostable material forming the subject of the present disclosure may be produced by means of a first step of mixing the components, i.e., the coffee-based granular material and the binding agent, preferably methylcellulose. Preferably, these components are mixed in the presence of water to obtain a homogeneous mix. The weight ratio between the amount of water and the solid components (coffee-based granular material and binding agent) may be comprised between 1.2 and 1.5.

Once a homogeneous mix is obtained, it is subjected to moulding to achieve a material of the desired thickness, for example by means of extrusion or injection moulding.

In one or more embodiments, films and sheets can also be obtained starting from a suspension comprising coffee-based material, the at least one binding agent, preferably methylcellulose, and water, using techniques such as bubble-film extrusion.

The moulding step may be carried out using moulds having the geometry of the container that is to be obtained. The mix can subsequently be put under pressure to enable the material to assume the shape of the mould. Next, the material can be subjected to drying, for example by means of exposure to heat sources (inside ovens), microwave irradiation, infrared irradiation, drum drying, vacuum drying, freezer drying.

In one or more embodiments, following upon the moulding and drying steps, the material may be subjected to a step of washing and subsequent drying according to the methods outlined in the previous section. The washing step can contribute to hindering the migration of traces of the coffee-based material and of the binding agent from the material itself to the food product contained therein. The washing step may be conducted in cold conditions, at room temperature, or with hot water (even boiling water). Washing may be carried out for a time interval comprised between one second and one hour.

The compostable material may advantageously be used in the production of containers for food products, preferably capsules containing a dose of substance that can form a liquid product via introduction of water and/or steam.

The aforesaid material can also be used to contain and protect a compacted dose of substance, for example a compacted dose of coffee. One or more embodiments of the present disclosure provide a capsule that contains a dose of at least one substance that can be used in the preparation of a liquid product, where the dose is a compacted dose of coffee.

The dose of substance can be compacted by exerting pressure thereon or also using further compacting procedures that envisage, for example, the use of freezing, exposure to infrared radiation, or microwaves.

In various embodiments, the dose of substance may be ground coffee or some other precursor of a liquid product such as a beverage, tea, powdered chocolate or granular chocolate, but also products for the preparation of broths, soups, drinks, and infusions of various nature: this list is to be understood as being provided by way of non-limiting example. In the following, for simplicity, reference will be made to capsules for the preparation of coffee, with a dose that is understood as being constituted by ground coffee.

In one or more embodiments, the structure of the capsule comprising the disclosed compostable material may present different forms.

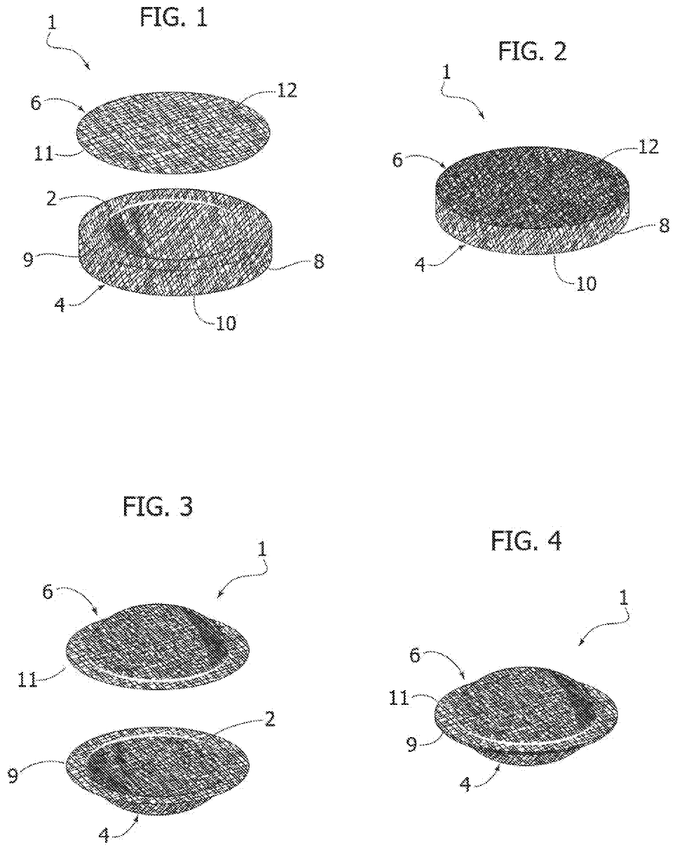

In one or more embodiments, as illustrated for example in FIGS. 1-4, the structure of the capsule 1 defines a chamber 2 for receiving the dose of substance and comprises a first body portion 4 and a second body portion 6. Just one or both of the two body portions may comprise, preferably may consist of, a compostable material as described herein. In one or more different embodiments, one of the two body portions may comprise a compostable material, for example selected from: paper, cellophane, cellulose and derivatives thereof, polymers extracted from biomass (e.g., polysaccharides such as starch and its derivatives); synthetic polymers (e.g., polylactic acid—PLA deriving from fermentation of starch, polybutyrate adipate terephthalate PBAT); polymers produced by micro-organisms or by genetically modified bacteria (e.g., polyhydroxyalkanoates such as PHA, PHB, PHV, PHH); polymers from fossil monomers (e.g., polybutylsuccinate—PBS, polycaprolactone—PCL); polyanhydrides, polyvinyl alcohol; this category may include also mixtures of the aforesaid compounds and/or the introduction of additives, such as nanoparticles (e.g., talcum, cloisite).

Each body portion comprises an outer surface and an inner surface. The first body portion 4 and the second body portion 6 are joined with the respective outer surfaces facing the outside of the capsule and the respective inner surfaces facing one another and the inside of the capsule. At least one of the first and second body portions comprises a concave inner surface. Preferably, at least one of the first and second body portions may comprise a convex outer surface. At least one of the first and second body portions comprises, preferably consists of, the compostable material forming the subject of the present disclosure.

In the example illustrated in FIGS. 1 and 2, the capsule may comprise a first body portion 4 that develops on a side wall 8 and on a first end wall 10. The second body portion 6 develops only on a second end wall 12. For instance, the first end wall 10 and the second end wall 12 may be transverse walls—here defined merely for simplicity also as “bottom wall” and “closing wall”. In the example illustrated in FIG. 2, the capsule 1 is a hermetically sealed capsule, with the end walls free of openings. The end wall 10 is made of a single piece with the side wall 8.

The second end wall (or closing wall) 12 is secured—via the peripheral edge 11—to the side wall 8—at the peripheral edge 9. Adhesion is ensured simply by moistening and joining the parts at the mouth part of the first body portion 4.

The first body portion 4 may present a cup-like or tray-like shape diverging starting from the bottom 10 towards the end closed by the closing wall 12. This divergent shape may be frustoconical. The capsule 1 may present different shapes, for example a substantially cylindrical or substantially hemispherical or cup shape. The bottom wall 10 may present the conformation of a concave vault, with the concavity of the vault directed towards the outside of the capsule 1. Also in this case, the choice of this conformation does not have a limiting nature in so far as the capsule 1 could have—for example—a vault-like bottom wall 10 with concavity facing the inside of the capsule 1, or else a plane or substantially plane bottom wall 10. In one or more embodiments, the bottom wall 10 may present a relief that extends towards the inside of the capsule for a height that makes it possible to be set in contact with the closing wall 12.

The structure of the end walls 10 and 12 of the two body portions may be rendered symmetrical so as to enable dispensing of the beverage independently either on one side or on the other of the capsule, this being an option of differentiation useful for design of the apparatus dispensing the liquid product.

In one or more embodiments, at least one of said end wall 10, said side wall 8, and said closing wall 12 of the capsule may comprise, preferably may consist of, the compostable material forming the subject of the present disclosure. The capsule may moreover comprise at least one of said end wall 10, said side wall 8, said closing wall 12 made of a compostable material selected from paper, cellophane, cellulose and derivatives thereof, polymers extracted from biomass (e.g., polysaccharides such as starch and its derivatives); synthetic polymers (e.g., polylactic acid—PLA deriving from fermentation of starch, polybutyrate adipate terephthalate PBAT); polymers produced by micro-organisms or by genetically modified bacteria (e.g., polyhydroxyalkanoates such as PHA, PHB, PHV, PHH); polymers from fossil monomers (e.g., polybutylsuccinate—PBS, polycaprolactone—PCL); polyanhydrides, polyvinyl alcohol; this category may include also mixtures of the aforesaid compounds and/or the introduction of additives, such as nanoparticles (e.g., talcum, cloisite).

In the example illustrated in FIGS. 3 and 4, the capsule 1 has a first body portion 4 and a second body portion 6 both having a lenticular (or shell-like) shape. The two portions 4 and 6 are joined at a respective peripheral edge 9, 11. The inner surfaces thereof face and define a chamber 2 for receiving the dose of substance. The peripheral edge 9, 11 may extend towards the outside of the capsule, in particular towards the outside of the first and second body portions.

In the embodiments here considered by way of example it is envisaged that at least one of the first and second body portions of the capsule can be perforated by the tips of a machine for dispensing coffee in order to enable the liquid product to flow out of the cartridge 1 through said portions.

In other embodiments, at least one between the first body portion 4 and the second body portion 6 may present a structure comprising at least one hole (for example, a porous structure) through which said liquid product can flow from the capsule 1.

In one or more embodiments, when the first body portion 4 comprises a side wall 8 and a first end wall 10 and the second body portion 6 comprises only a second end wall 12, at least one from among said side wall 8, said first end wall 10, and said second end wall may include a structure comprising at least one hole (for example, a porous structure) through which the aforesaid liquid product can flow from the capsule 1.

The present disclosure moreover provides a method for producing a capsule 1 containing a dose of at least one substance, preferably for the preparation of a liquid product by means of liquid and/or steam introduced into the capsule 1. The method may comprise the steps of:
providing a first body portion 4 to contain the dose of food substance;
arranging said dose in said first body portion 4;
closing the capsule 1 with a second body portion 6 applied for closing said first body portion 4 at a respective peripheral edge 9; 11,

the method comprising:
making at least one between said first body portion 4 and said second body portion 6 of a compostable material—forming the subject of the present disclosure—comprising, optionally consisting of, a coffee-based granular material and a binding agent selected from methylcellulose, derivatives thereof, mixtures thereof;
moistening at least one between said first body portion 4 and said second body portion 6 at the respective peripheral edge 9; 11;
setting said first body portion 4 and said second body portion 6 of the capsule in contact at the respective peripheral edge 9; 11;
optionally drying the capsule 1.

In one or more embodiments, the moistening step may be carried out with water and/or an aqueous solution comprising methylcellulose, preferably in an amount of between 0.01 wt % and 10 wt %.

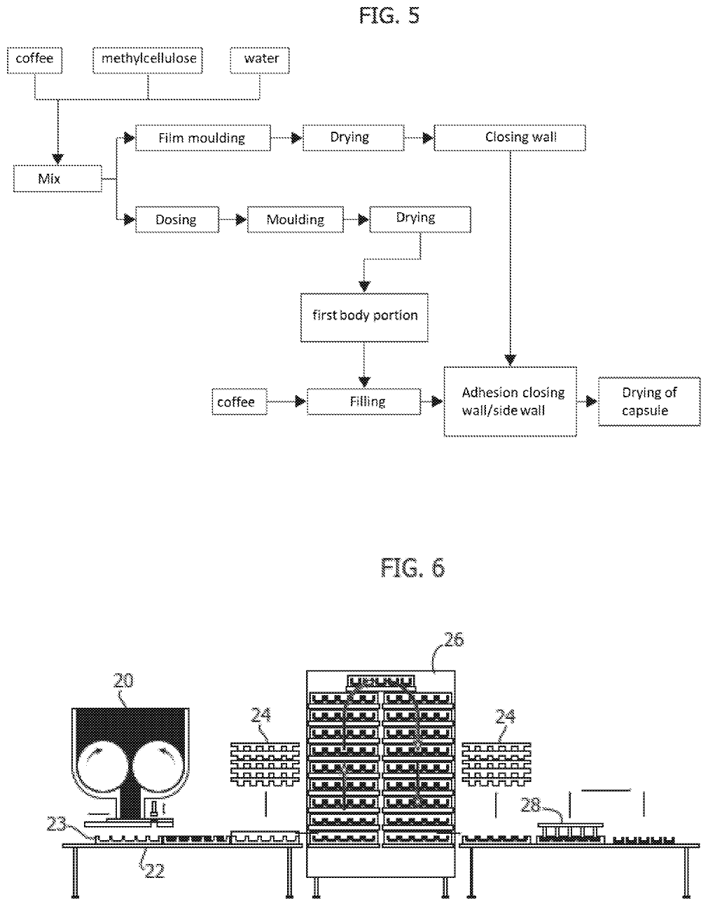

FIG. 5 shows a block diagram of a method for producing the compostable material forming the subject of the present application and a capsule obtained with said material, such as the capsule illustrated in FIGS. 1 and 2. FIG. 6 is a schematic illustration of the step of production of a body portion of the capsule, i.e., the body portion 4 comprising the bottom wall 10 and the side wall 8.

As illustrated in FIG. 5, coffee, methylcellulose, and water are mixed to form a homogeneous mix. The mix is divided into two fractions: a first fraction for producing the body portion 6 that develops only on the end wall (or closing wall) 12; and a second fraction for producing the body portion 4 of the capsule that has a cup shape and that comprises an end wall (or bottom wall 10) and a side wall 8.

In the case of the production of the end wall (or closing wall) 12, the mix is subjected to a moulding step, for example a rotary-moulding step, to form a film. After a drying step, for example in a paternoster oven, the closing wall 12 of the capsule 1 is obtained from the film material.

The portion of mix for the production of the body 4 of the capsules comprising a bottom wall 10 and a side wall 8 is transferred into a doser and distributed in a multiple-cavity mould. After a drying step, the body of the capsule is filled with a dose of substance, for example coffee, and subsequently closed by getting the closing wall 12 to adhere.

The reference number 20 in FIG. 6 designates the doser for the mix, the reference number 22 designates the mould with multiple cup-shaped cavities 23. The pressure exerted by a punch 24 enables moulding of the material and formation of the cup shape. The material thus moulded undergoes drying, preferably at a temperature of between 15° C. and 105° C., in a paternoster oven 26. Upon exit from the oven 26, the punch 24 is removed from the mould 22, and this is followed by a step of extraction of the compostable material by means of a purposely provided extractor 28. The compostable material that has assumed a cup shape is subjected to a step of filling with the dose of substance, for example coffee.

Next, the capsule is closed by joining the closing wall 12 to the side wall 8 of the body 4 of the capsule 1 at the respective peripheral edges 9,11.

Advantageously, the closing wall 12 can be joined to the body portion 4, in particular to the side wall 8, without any need to use adhesive substances, glues, welds; the adhesion of the two parts may, in fact, be obtained by moistening the regions to be set in contact. Moistening of the parts to be set in contact may be obtained, for example, by means of techniques of coating, spraying, application, with a paintbrush, of water or else an aqueous solution comprising methylcellulose (in a concentration of between 0.01 wt % and 10 wt %).

On the parts set in contact a pressure may be exerted to favour adhesion thereof.

Optionally, a drying step may follow, carried out, for example, in a paternoster oven, as described previously.

The capsule thus obtained, in which the first body portion 4 is connected to the second body portion 6 by contact adhesion, advantageously does not envisage the use of synthetic adhesive substances.

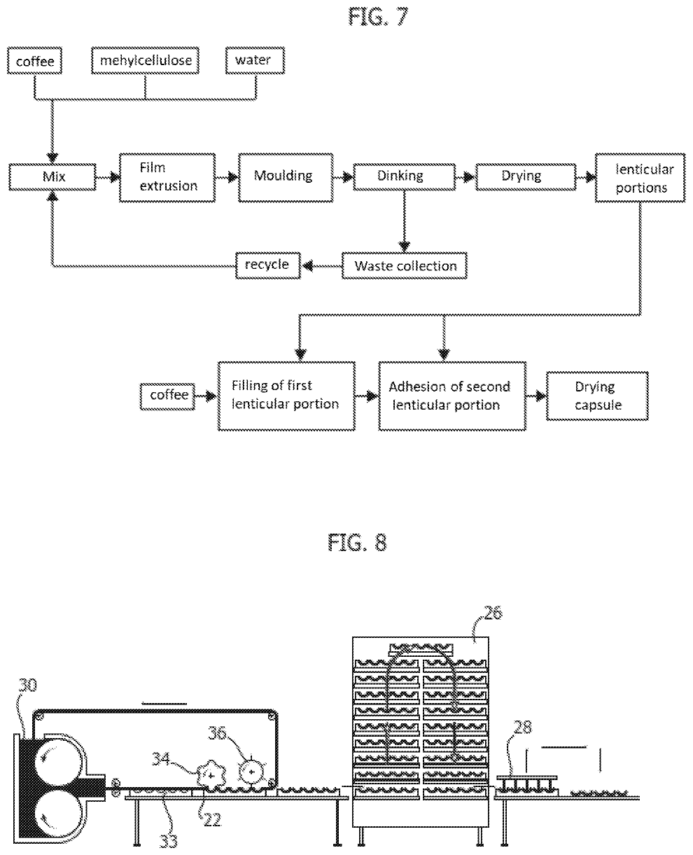

FIG. 7 shows a block diagram with the steps of a method that can be used for the production of the compostable material forming the subject of the present disclosure and of a capsule, for example as illustrated in FIGS. 3 and 4. In particular, coffee, methylcellulose, and water are mixed to form a homogeneous mix. The mix is subjected to extrusion to obtain a film.

The film of compostable material thus obtained is subjected to forming in a mould of a lenticular shape, dinking, and drying. The portions of excess material are collected and used in a new cycle. After drying, a pre-dosed dose of coffee is inserted in one of the two body portions of a lenticular shape. The second body portion is positioned on the first body portion at the respective peripheral edges 9,11 so as to obtain closing of the capsule. Also in this case, in order to obtain adhesion of the two portions, it is sufficient to moisten the portions of the peripheral edges to be set in contact. On the parts set in contact there may be exerted a pressure to favour adhesion thereof. Optionally, this may be followed by a drying step, carried out, for example, in a paternoster oven, as described previously.

The capsule thus obtained, in which the first body portion 4 is connected to the second body portion 6 by contact adhesion, advantageously does not envisage the use of synthetic adhesive substances.

FIG. 8 illustrates an extruder 30 from which a film of compostable material is obtained that is laid on a multiple-cavity mould 32 comprising cavities having a lenticular shape 33. The pressure exerted by a rotary punch 34 will enable the material to assume the lenticular shape. A rotary dink 36 cuts and divides the various portions obtained. The portions in excess are collected and return to the extruder 30. FIG. 8 illustrates a paternoster oven in which the material is subjected to drying. Upon exit from the oven 38, there follows a step of extraction of the compostable material from the mould 32 by means of a purposely provided extractor 28.

The capsules obtained can, as a whole, be qualified as compostable according to the UNI EN 13432 standard.

In various embodiments, the sequence of use of the capsules may substantially correspond to the sequence of use of the capsule described in EP-A-0 507 905 or in WO2012/077066 A1, which renders any repetition of the corresponding description superfluous herein. This sequence of use, which is to be understood as being provided purely by way of example and such as to admit of different variants, is to be deemed in itself known, which renders a more detailed description thereof superfluous.

The compostable material forming the subject of the present disclosure consequently presents the advantage of being usable both to contain the food product and to provide a support resistant to heating, pressure, and possible perforation by the perforating tips of machines for dispensing liquid products (such as coffee), and subsequently being disposable as compostable material.

In the application here considered, i.e., in the case where the compostable material is used for packaging food products that are to undergo heating and introduction of water and/or steam at a temperature comprised between 50° C. and 100° C. and a pressure between 1 bar and 30 bar, a compostable material could undergo phenomena of softening, melting, alteration of the food product contained therein, a circumstance basically due to the fact that the material is of natural origin.

The compostable material forming the subject of the present disclosure enables to overcome said drawback in so far as the specific combination of a coffee-based granular material and a binding agent, preferably methylcellulose, in the quantitative ratios indicated, presents characteristics of stiffness such as to favour maintenance of the structural characteristics in the conditions of temperature and pressure of dispensing of the beverage.

The specific combination of the components of the composite material in the specific weight ratio moreover confers thermomechanical strength to the material, for example when the material is subjected to processes of vacuum packaging or packaging in a modified atmosphere.

One or more embodiments consequently enable a material that presents characteristics of compostability, which presents particular stability and strength in regard to mechanical and thermal stresses, as well as to pressure, and which may be used in machines for dispensing coffee.

### Examples

Comparative experimental tests were conducted on:
compostable materials forming the subject of the present disclosure, comprising coffee-based granular material and methylcellulose, with and without glycerol as plasticizing agent; and
compostable materials comprising coffee-based granular material and alginate as binding agent, with and without glycerol as plasticizing agent.

These materials were subjected to migration tests using a standard protocol of evaluation of the total dissolved solids (TDS).

First Set of Experiments

The migration tests have been carried out by dipping the compostable material in hot water, at a temperature of between 80° C. and 90° C., keeping the aqueous solution stirred, and evaluating the variation of the colour of the solution after a period of a few minutes, generally two minutes.

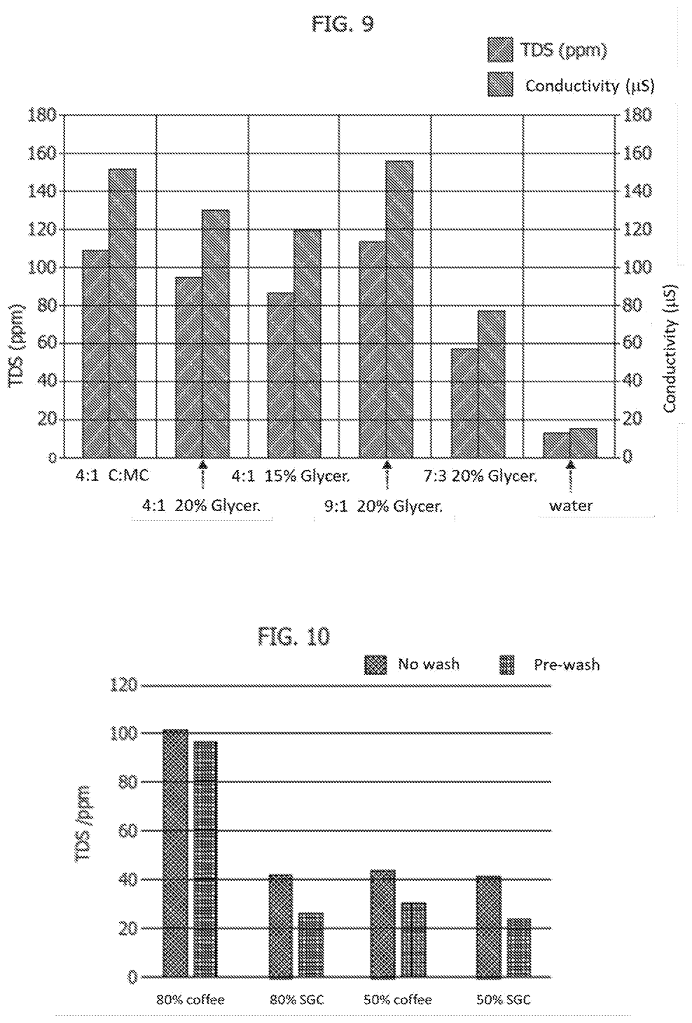

The first set of experiments was conducted on compostable materials having a thickness of 2.5 mm, comprising coffee, methylcellulose, and optionally glycerol in the following quantitative ratios:
coffee and methylcellulose in a weight ratio of 4:1 (4:1 C:CMC in the graph of FIG. 9);
coffee and methylcellulose in a weight ratio of 4:1 in combination with glycerol present in an amount equal to 20 wt % (4:1 20% Glycer. in the graph of FIG. 9);
coffee and methylcellulose in a weight ratio of 4:1 in combination with glycerol present in an amount equal to 15 wt % of the material (4:1 15% Glycer. in the graph of FIG. 9);
coffee and methylcellulose in a weight ratio of 9:1 in combination with glycerol present in an amount equal to 20 wt % (9:1 20% Glycer. in the graph of FIG. 9); and
coffee and methylcellulose in a weight ratio of 7:3 in combination with glycerol present in an amount equal to 20 wt % (7:3 20% Glycer. in the graph of FIG. 9).

Control tests were carried out with just water.

The results of the migration test show that, when present in combination with coffee and methylcellulose in the specific weight ratio of 4:1, glycerol contributes to reducing the amount of total dissolved solids (TDS).

These materials, however, are subject to decoloration, which may in particular be observed during the step of drying at 60° C. for five hours and when the materials are subjected to a pressure of approximately 250 Pa. Furthermore, the materials present the disadvantage of not guaranteeing an optimal surface adhesion between the parts of the capsule set in contact during the process of production thereof.

Second Set of Experiments

Compostable materials comprising coffee, sodium alginate as binding agent, and glycerol were tested. The materials obtained did not present satisfactory characteristics, particularly during production of the capsule. The methods of production of the material moreover require conditions of acid pH during cross-linking of the alginate in the presence of glycerol in order to obtain a material that is sufficiently flexible to be workable. An acid pH, however, causes alterations in the colour of the compostable material obtained and consequently capsules with an unsatisfactory appearance from an aesthetic standpoint. Migration tests moreover demonstrated the tendency of glycerol to migrate from the compostable material.

Third Set of Experiments

Compostable materials in the form of disks having a diameter of 50 mm and a thickness of 1.5 mm and comprising different combinations of components were subjected to migration tests after dipping and boiling in deionised water (DI water) for 30 minutes. In particular, there were obtained:
disks of material comprising coffee and methylcellulose in the weight ratio of 80:20;
disks of material comprising spent ground coffee (SGC) and methylcellulose in the weight ratio of 80:20;
disks of material comprising coffee and methylcellulose in the weight ratio of 50:50; and
disks of material comprising spent ground coffee (SGC) and methylcellulose in the weight ratio of 50:50.

The results of the graph of FIG. 10 show a reduced migration for the disks that comprise spent ground coffee instead of coffee. Moreover, washing of the disks prior to the experimental tests proved useful to reduce migration further.

The disks subjected to migration tests were also analysed from a dimensional standpoint. The analyses showed that the step of washing of the disks, albeit favourable for reducing migration, causes disk shrinkage.

For instance, the diameter of the disks comprising coffee and methylcellulose in the weight ratio of 80:20 showed a variation from a value of 50 mm to a value 46.9 mm. Disks comprising spent ground coffee and methylcellulose in a weight ratio of 50:50 showed a variation of the diameter from 50 mm to 40.2 mm. Disks comprising spent ground coffee and methylcellulose in a weight ratio of 80:20 showed a diameter variation from 50 mm to 47.2 mm.

Fourth Set of Experiments

Further migration tests were conducted by incorporating edible colorants in the mix. In particular, a blue colorant (GNT ExBerry Shade Blue) was used in an amount equal to 0.5 ml for 20 g of mix used to obtain a compostable material comprising coffee and methylcellulose in a weight ratio of 80:20; disks of a diameter of 50 mm and a thickness of 1.5 mm were obtained.

The tests were conducted in deionised cold water at room temperature and also in deionised water at a temperature of approximately 90° C.

No migration of the dye into the aqueous solution was observed, thus proving the suitability of the material forming the subject of the present disclosure for packaging food products.

Fifth Set of Experiments

Compostable materials comprising coffee and methylcellulose in different quantitative proportions were subjected to analysis in the various steps of production and processing of the material.

In particular, the analysed compostable materials comprised a quantitative ratio between coffee and methylcellulose equal to 80:20, 50:50, 30:70.

The above compostable materials were obtained from a mix that comprised an amount of water of between approximately 55 wt % and 60 wt % with respect to the total weight of the mix.

Compostable materials having a weight ratio between coffee and methylcellulose of 80:20 (80:20) are obtained from a soft mix that is easy to mix; compostable materials having a weight ratio between coffee and methylcellulose 50:50 (50:50) derive from a mix with medium hardness, whereas compostable materials having a ratio between coffee and methylcellulose of 30:70 (30:70) derive from a mix that requires a long mixing time and is difficult to work.

In the steps of moulding of the material, the materials 20:80 and 50:50 have a good surface adhesion and are easy to mould without causing tearing. Moreover, the materials 50:50 are suitable for the production of thin sheets.

The materials 80:20 moreover present the advantage that, during the steps of production, the mix can dry even at low temperatures for a period of time of approximately two/three hours, without undergoing structural modifications. With the increase in the amount of methylcellulose (materials 30:70), the material can undergo phenomena of shrinkage during drying, i.e., phenomena that can generate stresses and induce failure of the material.

Materials comprising coffee and methylcellulose with a weight ratio of 80:20 but also of 50:50 can be easily extracted from the mould cavities and have few or no surface defects. Moreover, the materials 80:20 have a light colour, and the colour is darker in the materials 50:50 and 30:70.

The results obtained in the various sets of experimental tests showed that compostable materials comprising coffee-based material in combination with a binding agent, preferably cellulose, present advantages over compostable materials comprising other binding agents in combination with coffee. Compostable materials comprising coffee and alginate as binding agent, possibly in the presence of glycerol, did not prove to be suitable for producing containers for foodstuffs, in particular rigid containers, such as capsules containing a dose of substance for the production of liquid products.

The presence of glycerol as plasticizing agent does not afford evident advantages for the compostable material and may undergo phenomena of migration.

A specific amount of binding agent, preferably methylcellulose, preferably comprised between 20 wt % and 50 wt % of the compostable material, confers optimal properties on the material in terms of process of production of the capsules.

The use of spent ground coffee in combination with the binding agent, preferably methylcellulose, moreover proves advantageous both in terms of costs and in terms of migration.

Without prejudice to the underlying principle, the details of construction and the embodiments may vary, even significantly, with respect to what has been illustrated herein purely by way of non-limiting example, without thereby departing from the scope of protection. This scope is defined by the annexed claims.

1. A compostable material for the packaging of food products comprising a coffee-based granular material and at least one binding agent selected from methylcellulose, methylcellulose derivatives, mixtures thereof.

2. The compostable material according to claim 1, wherein said granular coffee-based material comprises, preferably consists of, at least one of roasted and ground coffee, spent ground coffee, mixtures thereof.

3. The compostable material according to claim 1, wherein the methylcellulose derivatives are selected in the group consisting of hydroxypropylmethylcellulose, carboxymethylcellulose, hydroxymethylethylcellulose.

4. The compostable material according to claim 1, wherein the weight ratio between said coffee-based granular material and said binding agent is comprised between 1:1 and 4:1, preferably is equal to 4:1.

5. The compostable material according to claim 1, wherein said compostable material consists of coffee-based granular material and methylcellulose as binding agent.

6. The compostable material according to claim 1, wherein said compostable material is free of plasticizing agents, preferably free of polyol compounds.

7. A capsule suitable to contain a dose of at least one food substance, said capsule comprising a compostable material according to claim 1.

8. The capsule according to claim 7, wherein said capsule contains a dose of at least one food substance for the preparation of a liquid product, said capsule comprising a first body portion and a second body portion, wherein each of said first body portion and said second body portion comprises an outer surface and an inner surface,
wherein the first body portion and the second body portion are joined with the respective outer surfaces facing the outside of the capsule and the respective inner surfaces facing each other and the inside of the capsule,
wherein at least one of said first and said second body portion comprises a concave inner surface,
wherein at least one of said first body portion and said second body portion comprises, preferably consists of, the compostable.

9. The capsule according to claim 8, wherein said first body portion develops on a side wall and on a first end wall and said second body portion develops only on a second end wall.

10. The capsule according to claim 8, wherein said first body portion and said second body portion have a lenticular shape and are joined at a respective peripheral edge in such a way that the inner surfaces face each other.

11. The capsule according to claim 8, wherein said first body portion is connected to said second body portion by contact adhesion and wherein said capsule is free of synthetic adhesive substances.

12. The capsule according to claim 8, wherein at least one of said first body portion and said second body portion has a structure comprising at least one hole through which said liquid product can flow from the capsule.

13. The capsule according to claim 9, wherein at least one of said side wall, said first end wall and said second end wall has a structure comprising at least one hole through which said liquid product can flow from the capsule.

14. The capsule according to claim 1, wherein one of said two body portions comprises a compostable material preferably selected in the group consisting of paper, cellophane, cellulose, polymers extracted from biomass, synthetic polymers, polymers produced by microorganisms or by genetically modified bacteria, polymers from fossil monomers, polyanhydrides, polyvinyl alcohol, mixtures thereof.

15. The capsule according to claim 8, wherein said dose of at least one substance for the preparation of a liquid product is a compacted dose of coffee.

16. A method for making a capsule containing a dose of at least one food substance, the method comprising the steps of:
providing a first body portion for containing said dose,
arranging said dose in said first body portion,
closing the capsule with a second body portion applied to close said first body portion at a respective peripheral edge,
the method comprising:
providing at least one of said first body portion and said second body portion of a compostable material according to claim 1,
moistening at least one of said first body portion and said second body portion at said peripheral edge,
setting said first body portion and said second body portion in contact at said peripheral edge.
